(19) United States
(12) Patent Application Publication
(10) Pub. No.: US 2026/0348479 A1
(43) Pub. Date: Nov. 5, 2026

(54) VALVE DEVICE

(71) Applicant: FUJIKIN INCORPORATED, Osaka (JP)

(72) Inventors: Kohei SHIGYOU, Osaka (JP); Tomohiro NAKATA, Osaka (JP)

(21) Appl. No.: 19/722,032

(22) Filed: Jun. 26, 2026

Related U.S. Application Data
(63) Continuation of application No. PCT/JP2024/041577, filed on Nov. 25, 2024.

(30) Foreign Application Priority Data
Dec. 27, 2023 (JP) 2023-220853

(51) Int. Cl. F16K 7/14; F16K 27/02

(52) U.S. Cl. CPC F16K 7/14; F16K 27/0236

(57) ABSTRACT

A plate support surface and a contact surface are formed on a bottom surface of a housing recess of a body around a first outflow passage in this order. A pressing surface and an abutment surface are formed on a lower surface of an inner member around a second outflow passage in this order, the pressing surface is provided thereon with a pressing protrusion. The body, an orifice plate, the inner member, and a fixing ring are configured such that, during tightening of the fixing ring relative to the housing recess until the abutment surface comes into close contact with the contact surface, the pressing protrusion presses the orifice plate to seal a seal portion between the orifice plate and the body and a seal portion between the orifice plate and the inner member.

### CROSS REFERENCE TO RELATED APPLICATION

This application is a continuation application under 35 U.S.C. § 120 of No. PCT/JP2024/041577, filed Nov. 25, 2024, which is incorporated herein by reference, and which claims priority to Japanese Application No. 2023-220853, filed Nov. 27, 2023. The present application likewise claims priority under 35 U.S.C. § 119 to Japanese Application No. 2023-220853, filed Nov. 27, 2023, the entire content of which is also incorporated herein by reference.

### TECHNICAL FIELD

The present disclosure relates to a valve device incorporating an orifice.

### BACKGROUND

In semiconductor manufacturing processes, pressure-type flow rate controllers having valve devices with built-in orifices are used in fine processing applications such as ALD (Atomic Layer Deposition) and ALE (Atomic Layer Etching) in order to supply accurately metered process gas to a processing chamber within a short period of time. In the valve device with a built-in orifice disclosed in Japanese U.S. Pat. No. 4,137,267, an orifice plate is disposed on a body, and a valve seat member, an inner disk, a diaphragm, and the like are placed on the orifice plate. A protruding ridge of a valve seat member seals and fixes the orifice plate by screwing a bonnet onto the body.

### SUMMARY

Some pressure-type flow rate controllers having valve devices with built-in orifices are provided with a flow rate self-diagnosis function configured to determine whether an abnormality exists in a controlled flow rate due to clogging, corrosion, or the like of the orifice. In the flow rate self-diagnosis function, the presence or absence of an abnormality is detected by comparing an initial pressure drop characteristic of the device with a pressure drop characteristic measured at the time of diagnosis. Investigation into the cause of abnormalities detected by the flow rate self-diagnosis function in conventional valve devices having built-in orifices suggested that the abnormalities were caused by changes in leakage occurring at a seal portion of the orifice plate because the seal portion of the orifice plate had poor surface contact properties and gradually deformed (curved) over time. Accordingly, there is a need for an arrangement in which deformation of the orifice plate is prevented while ensuring surface contact properties and sealing performance between the orifice plate and clamping portions configured to clamp the orifice plate therebetween.

In order to ensure that a seal portion between the orifice plate and members configured to clamp the orifice plate has appropriate surface contact properties and sealing performance, it is also necessary to control the tightening torque applied when fastening the bonnet to the body. In such a case, however, differences in surface roughness of threaded portions between the bonnet and the body may result in variations in tightening angle even when the same torque is applied. As a result, an excessive tightening force may be applied to the orifice plate, thereby deforming the orifice plate, or alternatively, sufficient tightening force may not be applied to members such as the orifice plate, thereby resulting in insufficient sealing performance. Accordingly, it is necessary to equalize the force applied to the orifice plate.

Accordingly, the present disclosure is to provide a valve device capable of ensuring surface contact properties and sealing performance at a seal portion between an orifice plate and members configured to clamp the orifice plate therebetween.

A valve device according to one aspect of the present disclosure includes a body in which a first inflow passage and a first outflow passage are formed, the body having a housing recess that opens at an upper surface thereof and in which the first inflow passage and the first outflow passage open at a bottom surface of the housing recess; an orifice plate disposed on the bottom surface of the housing recess and having an orifice formed therein; an inner member disposed within the housing recess and having a second inflow passage communicating with the first inflow passage and a second outflow passage communicating with the first outflow passage; and a fixing ring positioned above the inner member and configured to be threadedly engaged with a threaded portion formed on an inner peripheral surface of the housing recess to press the inner member toward the bottom surface. The first outflow passage opens at a center portion of the bottom surface of the housing recess, and a plate support surface having an annular shape and a contact surface having an annular shape are formed on the bottom surface around the first outflow passage in this order. The second outflow passage opens at a center portion of a lower surface of the inner member, and a pressing surface having an annular shape and an abutment surface having an annular shape are formed on the lower surface around the second outflow passage in this order, the pressing surface being provided thereon with a pressing protrusion having an annular shape. The body, the orifice plate, the inner member, and the fixing ring are configured such that, during tightening of the fixing ring relative to the housing recess until the abutment surface comes into close contact with the contact surface, the pressing protrusion presses the orifice plate to seal a seal portion between the orifice plate and the body and a seal portion between the orifice plate and the inner member.

### BRIEF DESCRIPTION OF THE DRAWINGS

In the drawings:

FIG. 1 is a cross-sectional view of a valve device according to one embodiment of the present disclosure;

FIG. 2 is an enlarged cross-sectional view showing a principal portion of the valve device shown in FIG. 1;

FIG. 3 is a perspective view of an orifice plate;

FIG. 4A is a perspective view of an inner member, and FIG. 4B is a cross-sectional view of the inner member;

FIG. 5A is a perspective view of a fixing ring, and FIG. 5B is a cross-sectional view of the fixing ring;

FIG. 6 is a plan view of a thrust ring;

FIG. 7A and FIG. 7B show positional relationships between a pressing protrusion of the inner member and a relief groove of the body; and

FIG. 8A and FIG. 8B show states in which an outer peripheral edge portion of the orifice plate is bent toward the relief groove as it pressed by the pressing protrusion.

### DETAILED DESCRIPTION

A valve device according to one embodiment of the present disclosure will now be described with reference to the drawings.

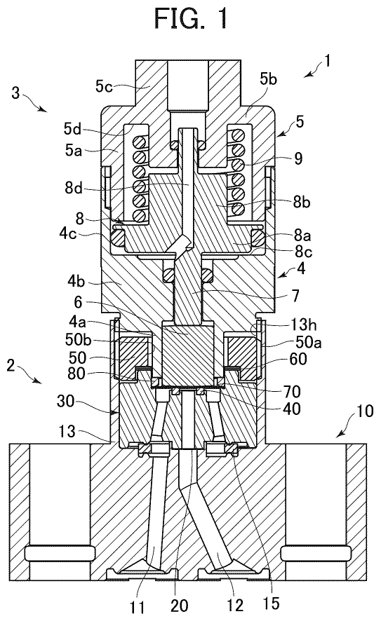

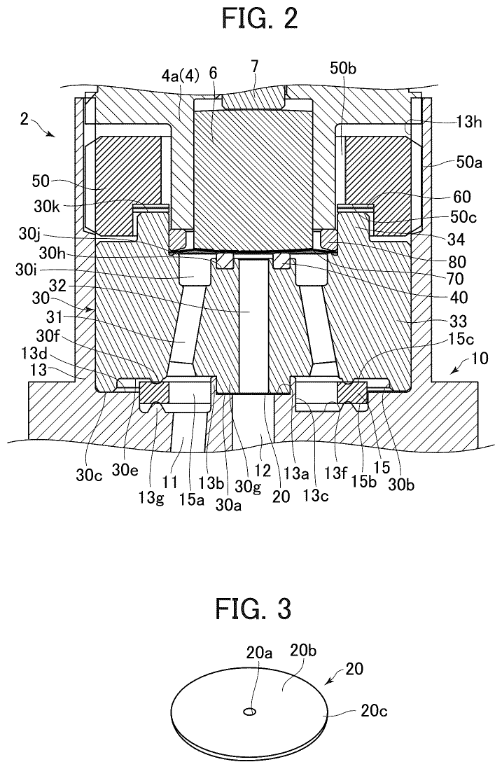

FIG. 1 is a cross-sectional view of the valve device 1 in a closed state according to the present embodiment. FIG. 2 is an enlarged cross-sectional view showing a principal portion of the valve device 1 shown in FIG. 1. The valve device 1 according to the present embodiment is a diaphragm valve device having a built-in orifice.

The valve device 1 is includes a body portion 2 and an actuator 3. In the following description, the actuator 3 side of the valve device 1 will be referred to as the upper side, and the body portion 2 side thereof will be referred to as the lower side.

The body portion 2 includes a body 10, a gasket 15, an orifice plate 20, an inner member 30, a valve seat 40, a fixing ring 50, thrust rings 60, a diaphragm 70, and a retainer adapter 80.

The body 10 is formed in a block shape from a metallic material such as stainless steel. A first inflow passage 11 and a first outflow passage 12 are formed in the body 10, and the body 10 includes a housing recess 13 having a circular cross-sectional opening at an upper surface of the body 10. In the present embodiment, the gasket 15, the orifice plate 20, the inner member 30, the valve seat 40, the fixing ring 50, the thrust rings 60, the diaphragm 70, and the retainer adapter 80 constitute valve elements.

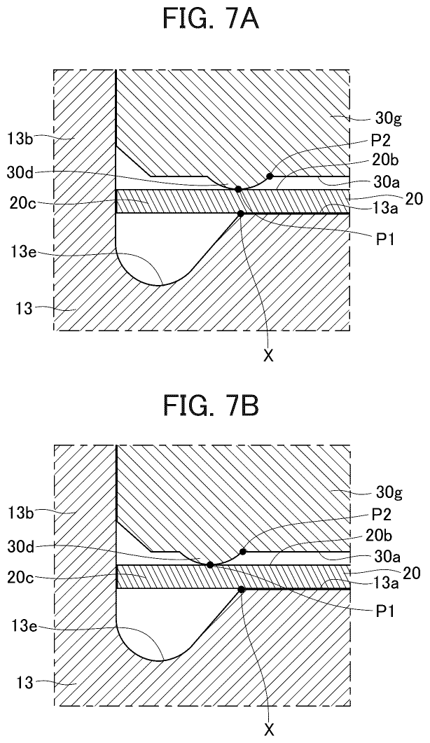

At a center portion of the bottom surface of the housing recess 13, the first outflow passage 12 opens. Around the first outflow passage 12, an annular plate support surface 13a, a cylindrical portion 13b, an annular recess 13c, and a contact surface 13d are concentrically formed in this order. The plate support surface 13a is planar, and an annular relief groove 13e (see FIGS. 7A and 7B) is formed at an outer peripheral edge thereof. The cylindrical portion 13b is provided so as to protrude upward. The first inflow passage 11 opens at a bottom surface 13f of the annular recess 13c, and an annular first protrusion 13g is provided thereon. The first protrusion 13g is positioned outward of the opening. The contact surface 13d is planar and serves as a surface against which an abutment surface 30c of the inner member 30, described later, comes into contact. A female threaded portion 13h is formed on an inner peripheral surface of an upper portion of the housing recess 13. The surfaces constituting the plate support surface 13a, the cylindrical portion 13b, the annular recess 13c, and the contact surface 13d correspond to the bottom surface of the housing recess 13.

The gasket 15 is an annular member formed of a soft material, and in the present embodiment is formed of a metal such as annealed stainless steel. In other words, the gasket 15 is formed of a metal softer than the body 10 and the inner member 30. The gasket 15 is disposed in the annular recess 13c and has a through-hole 15a communicating with the first inflow passage 11. Since the gasket 15 is formed of a soft material, when the valve elements are fixed to the body 10, the first protrusion 13g bites into a lower surface 15b of the gasket 15 to seal a connection portion between the first inflow passage 11 and the through-hole 15a.

FIG. 3 is a perspective view of the orifice plate 20. As shown in FIGS. 2 and 3, the orifice plate 20 is disposed on the body 10 and has an orifice 20a communicating with the first outflow passage 12. The orifice plate 20 is a thin metal disk made of stainless steel or the like, and the orifice 20a is formed at a center portion thereof. The orifice plate 20 is disposed on the plate support surface 13a of the housing recess 13 and is clamped and fixed between the plate support surface 13a and the pressing surface 30a of the inner member 30. The orifice plate 20 is configured to restrict an opening of the second outflow passage 32 of the inner member 30. Although only one orifice 20a is formed in the orifice plate 20 in the present embodiment, a plurality of orifices may alternatively be formed.

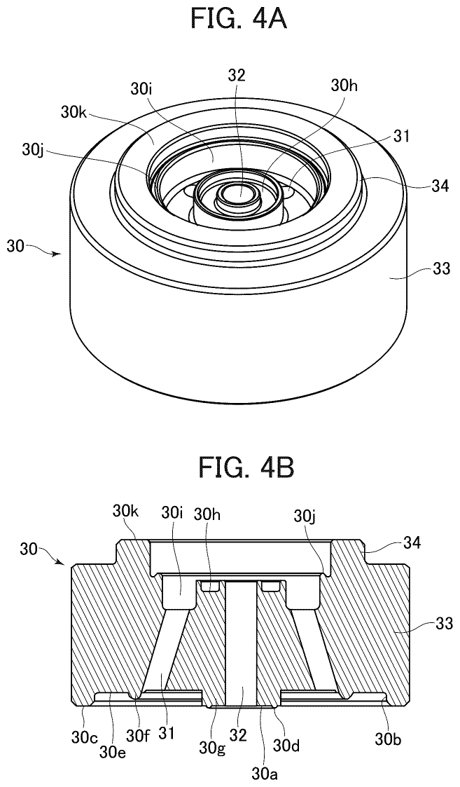

FIGS. 4A and 4B are a perspective view and a cross-sectional view, respectively, of the inner member 30. As shown in FIGS. 2, 4A and 4B, the inner member 30 is disposed within the housing recess 13 and positioned on the gasket 15 and the orifice plate 20. The inner member 30 is provided with four second inflow passages 31 and one second outflow passage 32. Each second inflow passage 31 communicates with the first inflow passage 11 via the through-hole 15a. The second outflow passage 32 communicates with the first outflow passage 12 via the orifice 20a. The inner member 30 is formed of a metal such as stainless steel having the same hardness as the body 10, and has a substantially stepped cylindrical shape including a large-diameter portion 33 and a small-diameter portion 34 positioned inward of the large-diameter portion 33 and having an upper end protruding upward. An outer peripheral surface of the large-diameter portion 33 fits with an inner peripheral surface of a lower portion of the housing recess 13 of the body 10, thereby positioning the inner member 30 itself relative to the body 10.

The second outflow passage 32 extends through a central portion of the inner member 30. At a center portion of a lower surface of the inner member 30, the second outflow passage 32 opens. Around the second outflow passage 32, an annular pressing surface 30a, an annular recess 30b, and an abutment surface 30c are concentrically formed in this order. The pressing surface 30a is planar, and an annular pressing protrusion 30d is provided on an outer peripheral side thereof. The four second inflow passages 31 open at a bottom surface 30e of the annular recess 30b, and annular second protrusion 30f is provided so as to surround the openings. The second protrusion 30f opposes the first protrusion 13g in the vertical direction over the entire circumference thereof. Due to the annular recess 30b, a central portion of the bottom portion of the inner member 30 defines a protruding portion 30g that protrudes downward. The pressing surface 30a and the pressing protrusion 30d are formed on the protruding portion 30g. When the valve elements are fixed to the body 10, the protruding portion 30g is inserted into the cylindrical portion 13b. The surfaces constituting the pressing surface 30a, the annular recess 30b, and the abutment surface 30c correspond to the lower surface of the inner member 30.

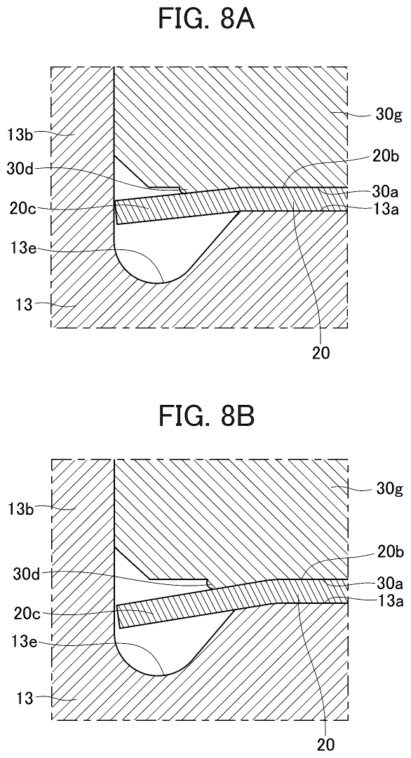

The abutment surface 30c is planar and comes into contact with the contact surface 13d of the body 10 when the valve elements are fixed to the body 10. The pressing protrusion 30d is configured to press an upper surface 20b of the orifice plate 20 to seal a connection portion between the second outflow passage 32 and the first outflow passage 12. The second protrusion 30f is configured to bite into an upper surface 15c of the gasket 15 to seal connection portions between the second inflow passages 31 and the through-hole 15a. Before pressing the orifice plate 20, the pressing protrusion 30d has an arcuate outer profile in cross section (see FIG. 7A and FIG. 7B). The pressing protrusion 30d deforms when pressing the orifice plate 20 and bending an outer peripheral edge portion 20c thereof (see FIG. 8A and FIG. 8B).

On an upper surface side of the inner member 30, the second outflow passage 32 opens at a center portion thereof. Around the second outflow passage 32, an annular seat placement groove 30h, an annular outflow groove 30i, a diaphragm support portion 30j, and an annular upper end surface 30k are concentrically formed in this order. The four second inflow passages 31 are formed at equal intervals in a circumferential direction. Each second inflow passage 31 opens at a lower end thereof into the annular recess 30b and opens at an upper end thereof into the annular outflow groove 30i. The number of second inflow passages 31 may be one or more. Each second inflow passage 31 is inclined inward as it extends upward. The lower end of each second inflow passage 31 communicates with the first inflow passage 11 of the body 10 through the through-hole 15a of the gasket 15.

The valve seat 40 is an annular member provided around the opening of the second outflow passage 32 on the upper surface of the inner member 30. The valve seat 40 is made of, for example, a fluororesin (PTFE). The valve seat 40 is fitted into the seat placement groove 30h of the inner member 30.

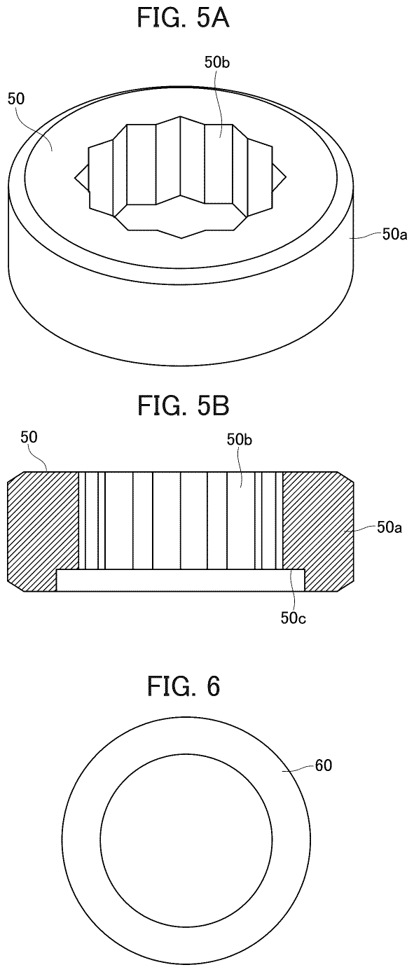

FIGS. 5A and 5B are a perspective view and a cross-sectional view, respectively, of the fixing ring 50. As shown in FIGS. 2, 5A and 5B, the fixing ring 50 is formed of a metal such as stainless steel and has a substantially annular shape. A male threaded portion 50a is formed on an outer peripheral surface of the fixing ring 50, and a double-hex structure configured to engage with a rotary tool is formed on an inner peripheral surface 50b thereof. A plate accommodation recess 50c is formed on a lower surface side of the fixing ring 50. Two thrust rings 60 are accommodated within the plate accommodation recess 50c.

FIG. 6 is a plan view of the thrust ring 60. The thrust ring 60 is a member formed by coating a stainless-steel washer-like plate with a sliding material. The thrust ring 60 reduces friction generated during rotational tightening by the fixing ring 50 when fixing the valve elements to the body 10, thereby preventing co-rotation of the inner member 30. The thrust ring 60 is not limited to a member formed by coating a stainless-steel plate with a sliding material and may be any member capable of reducing friction during rotation of the fixing ring 50. For example, the thrust ring 60 may be formed of a synthetic resin material having excellent sliding properties or may alternatively be a thrust bearing.

As shown in FIG. 2, the diaphragm 70 is disposed on the inner member 30 and is configured to communicate or block communication between the second inflow passages 31 and the second outflow passage 32 by separating from or coming into contact with the valve seat 40. The diaphragm 70 is formed by laminating a thin metal plate made of a special stainless steel or the like and a thin nickel-cobalt alloy plate and bulging a central portion thereof upward. The diaphragm 70 is supported by the diaphragm support portion 30j of the inner member 30 and is fixed by being pressed by a lower portion 4a of a bonnet 4 of the actuator 3 via a ring-shaped retainer adapter 80. The diaphragm 70 defines a part of a flow path and is elastically deformed by being pressed by a diaphragm presser 6. When the diaphragm 70 comes into contact with the valve seat 40, the flow path is closed, and when the diaphragm 70 separates from the valve seat 40, the flow path is opened.

As shown in FIG. 1, the actuator 3 includes the bonnet 4, an actuator cap 5, the diaphragm presser 6, a stem 7, a piston 8, and a compression coil spring 9.

The bonnet 4 has a substantially cylindrical shape and includes a lower portion 4a, an intermediate portion 4b, and an upper portion 4c. The lower portion 4a is inserted into the body 10, and the bonnet 4 is fixed to the body 10 by threaded engagement between an outer peripheral portion of an upper end portion of the lower portion 4a and the body 10. The lower portion 4a passes through the inner peripheral surface 50b of the fixing ring 50, and a lower end surface thereof presses the retainer adapter 80. The intermediate portion 4b is positioned above the lower portion 4a and has a hexagonal prism outer shape. The upper portion 4c is provided so as to extend upward from an outer edge portion of the intermediate portion 4b.

The actuator cap 5 has a substantially capped cylindrical shape and includes an outer cylindrical portion 5a, an upper cover portion 5b, and an inner cylindrical portion 5c. The actuator cap 5 is fixed to the bonnet 4 by threaded engagement between a lower end portion of the outer cylindrical portion 5a and the upper portion 4c of the bonnet 4. The upper cover portion 5b is provided so as to cover an upper end of the outer cylindrical portion 5a. The inner cylindrical portion 5c is connected to an inner end portion of the upper cover portion 5b. The bonnet 4 and the actuator cap 5 define an accommodation space 5d for accommodating the piston 8 and the compression coil spring 9.

The diaphragm presser 6 is provided above the diaphragm 70 and is supported by the lower portion 4a of the bonnet 4 to be movable in a vertical direction. The stem 7 is supported by the intermediate portion 4b of the bonnet 4 to be movable in the vertical direction and is configured to open and close the flow path by moving toward and away from the diaphragm 70.

The piston 8 is integrally formed with the stem 7, is provided above the stem 7, and is supported by the bonnet 4 and the actuator cap 5 to be movable in the vertical direction. The piston 8 includes a base portion 8a and an upper protruding portion 8b. The base portion 8a has a substantially disk shape, and the stem 7 is integrally provided on a lower surface thereof. The upper protruding portion 8b has a substantially cylindrical shape and extends upward from an upper surface of the base portion 8a. A pressure chamber 8c is defined between the lower surface of the base portion 8a of the piston 8 and an upper surface of the intermediate portion 4b of the bonnet 4. A drive fluid introduction passage 8d extending from an upper end of the piston 8 to the pressure chamber 8c is formed in the piston 8. The compression coil spring 9 is disposed between a lower surface of the upper cover portion 5b of the actuator cap 5 and the upper surface of the base portion 8a of the piston 8 and constantly biases the piston 8 downward.

When a drive fluid is supplied to the valve device 1, the drive fluid passes through the drive fluid introduction passage 8d and flows into the pressure chamber 8c. When the drive fluid flows into the pressure chamber 8c, the piston 8 rises against the biasing force of the compression coil spring 9. As a result, the piston 8 provided at the tip of the stem 7 moves to a top dead center position, and the diaphragm presser 6 moves upward due to the elastic force of the diaphragm 70 and the pressure of the fluid (gas), whereby the second inflow passages 31 and the second outflow passage 32 communicate with each other, and the valve device 1 is brought into an open state.

Next, positional relationships between the pressing protrusion 30d before deformation by pressing the orifice plate 20 and the relief groove 13e of the body 10 will be described with reference to FIG. 7A and FIG. 7B.

FIG. 7A and FIG. 7B show the positional relationships between the pressing protrusion 30d before pressing the orifice plate 20 and the relief groove 13e of the body 10. The outer diameter of the orifice plate 20 is configured to be larger than the outer diameter of the plate support surface 13a, and the outer peripheral edge portion 20c of the orifice plate 20 is positioned above the relief groove 13e. The pressing protrusion 30d has an arcuate outer profile in cross section. For example, with respect to the position of the pressing protrusion 30d before deformation provided on the pressing surface 30a, the position shown in FIG. 7A defines the innermost position (center-side position), and the position shown in FIG. 7B defines the outermost position (outer-side position). In the position shown in FIG. 7A, the pressing protrusion 30d is provided on the pressing surface 30a such that a top portion P1 thereof is positioned slightly outward of an inner end X of the relief groove 13e (an outer end of the plate support surface 13a) in the radial direction. In the position shown in FIG. 7B, the pressing protrusion 30d is provided on the pressing surface 30a such that an inner end P2 thereof is positioned slightly inward of the inner end X of the relief groove 13e in the radial direction. Preferably, the pressing protrusion 30d is located between the position shown in FIG. 7A (a first position) and the position shown in FIG. 7B (a second position) in the radial direction of the pressing surface 30a.

Next, an assembly procedure of the valve device 1 will be described with reference to FIG. 1 and FIG. 2.

The orifice plate 20 is disposed on the plate support surface 13a of the housing recess 13. The gasket 15 is disposed in the annular recess 13c of the housing recess 13. The valve seat 40 is fitted into the seat placement groove 30h of the inner member 30. The inner member 30 is placed in the housing recess 13 of the body 10. At this time, the protruding portion 30g of the inner member 30 is inserted into the cylindrical portion 13b. The two thrust rings 60 are disposed on the annular upper end surface 30k of the inner member 30. The male threaded portion 50a of the fixing ring 50 is threadedly engaged with the female threaded portion 13h of the housing recess 13, and the fixing ring 50 is tightened until the abutment surface 30c of the inner member 30 comes into contact with the contact surface 13d of the body 10, thereby fixing the gasket 15, the orifice plate 20, and the inner member 30 to the body 10.

The diaphragm 70 is disposed on the diaphragm support portion 30j of the inner member 30, the retainer adapter 80 is disposed on the diaphragm 70, and the bonnet 4 of the actuator 3 is screwed into the female threaded portion 13h of the housing recess 13. In this manner, the valve device 1 according to the present embodiment is assembled.

At the start of tightening of the fixing ring 50, the second protrusion 30f of the inner member 30 is in contact with the upper surface 15c of the gasket 15, and the pressing protrusion 30d of the inner member 30 is not yet in contact with the orifice plate 20. After the fixing ring 50 is tightened and the first protrusion 13g and the second protrusion 30f bites into the gasket 15, the pressing protrusion 30d comes into contact with the upper surface 20b of the orifice plate 20 (see FIG. 7A and FIG. 7B). When the fixing ring 50 is further tightened, the outer peripheral edge portion 20c of the orifice plate 20 is pressed by the pressing protrusion 30d and bends toward the relief groove 13e (see FIGS. 8A and 8B). At this time, the pressing protrusion 30d is crushed and deformed from the shape shown in FIG. 7A and FIG. 7B. Tightening of the fixing ring 50 is completed when the pressing surface 30a of the inner member 30 comes into close contact with the upper surface 20b of the orifice plate 20 and the abutment surface 30c of the inner member 30 comes into contact with the contact surface 13d of the body 10. The positional relationship between the pressing protrusion 30d and the relief groove 13e in FIG. 8A corresponds to that in FIG. 7A, and the positional relationship between the pressing protrusion 30d and the relief groove 13e in FIG. 8B corresponds to that in FIG. 7B.

As described above, in the valve device 1 according to the present embodiment, the fixing ring 50 is tightened until the abutment surface 30c of the inner member 30 comes into close contact with the contact surface 13d of the body 10, whereby sealing of a seal portion between the orifice plate 20 and the body 10 and between the orifice plate 20 and the inner member 30 is completed. Accordingly, sealing performance at the seal portion between the orifice plate 20 and members configured to clamp the orifice plate 20 therebetween can be easily ensured without torque management or the like. Therefore, sealing performance of the seal portion can easily be made uniform among different valve devices 1. In the present embodiment, tolerances are set such that the seal portion between the orifice plate 20 and the body 10 and between the orifice plate 20 and the inner member 30 is reliably sealed during a process from when the pressing protrusion 30d comes into contact with the upper surface 20b of the orifice plate 20 until the abutment surface 30c comes into close contact with the contact surface 13d. Such tolerances include a tolerance (accumulated tolerance) between the plate support surface 13a and the contact surface 13d of the body 10, a tolerance (accumulated tolerance) in thickness of the orifice plate 20, and a tolerance (accumulated tolerance) between the pressing surface 30a and the abutment surface 30c of the inner member 30.

The annular relief groove 13e is formed at the outer peripheral edge of the plate support surface 13a, and the outer peripheral edge portion 20c of the orifice plate 20 is pressed by the pressing protrusion 30d and bent toward the relief groove 13e. Accordingly, surface contact properties are improved, thereby improving sealing performance and suppressing deformation of the orifice plate 20.

The pressing protrusion 30d is located between the first position and the second position in the radial direction of the pressing surface 30a. The first position is a position at which the top portion P1 of the pressing protrusion 30d is located slightly outward of the inner end X of the relief groove 13e in the radial direction of the pressing surface 30a. The second position is a position at which the inner end P2 of the pressing protrusion 30d is located slightly inward of the inner end X of the relief groove 13e in the radial direction of the pressing surface 30a. Accordingly, surface contact properties are improved, thereby improving sealing performance and suppressing deformation of the orifice plate 20.

When the fixing ring 50 is tightened relative to the housing recess 13, the first protrusion 13g bites into the lower surface 15b of the gasket 15, and the second protrusion 30f bites into the upper surface 15c of the gasket 15, thereby forming respective seals. Accordingly, sealing of the seal portion of the orifice plate 20 and sealing of the seal portion of the gasket 15 can be performed simultaneously.

The present disclosure is not limited to the embodiments described above. A person skilled in the art may make various additions, modifications, and the like within the scope of the present disclosure.

For example, although the gasket 15 is formed of a metal such as annealed stainless steel, in cases where heat resistance is not highly required, the gasket 15 may alternatively be formed of a resin material such as a fluororesin (PCTFE). Further, although the thrust rings 60 are used to reduce friction of the fixing ring 50, the thrust rings 60 may be omitted as long as co-rotation of the inner member 30 does not occur.

What is claimed is:

1. A valve device comprising:
a body in which a first inflow passage and a first outflow passage are formed, the body having a housing recess that opens at an upper surface thereof and in which the first inflow passage and the first outflow passage open at a bottom surface of the housing recess;
an orifice plate disposed on the bottom surface of the housing recess and having an orifice formed therein;
an inner member disposed within the housing recess and having a second inflow passage communicating with the first inflow passage and a second outflow passage communicating with the first outflow passage; and
a fixing ring positioned above the inner member and configured to be threadedly engaged with a threaded portion formed on an inner peripheral surface of the housing recess to press the inner member toward the bottom surface,
wherein:
the first outflow passage opens at a center portion of the bottom surface of the housing recess, and a plate support surface having an annular shape and a contact surface having an annular shape are formed on the bottom surface around the first outflow passage in this order;
the second outflow passage opens at a center portion of a lower surface of the inner member, and a pressing surface having an annular shape and an abutment surface having an annular shape are formed on the lower surface around the second outflow passage in this order, the pressing surface being provided thereon with a pressing protrusion having an annular shape; and
the body, the orifice plate, the inner member, and the fixing ring are configured such that, during tightening of the fixing ring relative to the housing recess until the abutment surface comes into close contact with the contact surface, the pressing protrusion presses the orifice plate to seal a seal portion between the orifice plate and the body and a seal portion between the orifice plate and the inner member.

2. The valve device according to claim 1, wherein:
a relief groove having an annular shape is formed at an outer peripheral edge of the plate support surface; and
an outer peripheral edge portion of the orifice plate is bent toward the relief groove as the outer peripheral edge portion is pressed by the pressing protrusion.

3. The valve device according to claim 2, wherein:
the pressing protrusion, before deformation caused by pressing the orifice plate, has an arcuate outer profile in cross section and is located between a first position and a second position in a radial direction of the pressing surface;
the first position is a position in which a top portion of the pressing protrusion before deformation is located slightly outward of an inner end of the relief groove in the radial direction; and
the second position is a position in which an inner end of the pressing protrusion before deformation is located slightly inward of the inner end of the relief groove in the radial direction.

4. The valve device according to claim 1, further comprising:
a gasket disposed on the bottom surface of the housing recess and having a through-hole communicating with the first inflow passage and the second inflow passage,
wherein:
the bottom surface of the housing recess is provided with a first protrusion having an annular shape configured to surround openings of the first inflow passage and the first outflow passage;
the lower surface of the inner member is provided with a second protrusion having an annular shape configured to surround openings of the second inflow passage and the second outflow passage; and
when the fixing ring is tightened relative to the housing recess, the first protrusion bites into a lower surface of the gasket and the second protrusion bites into an upper surface of the gasket, thereby forming a seal between the gasket and the body and a seal between the gasket and the inner member.
